(19) United States
(12) Patent Application Publication
(10) Pub. No.: US 2018/0259298 A1
(43) Pub. Date: Sep. 13, 2018

(54) FAST-LOCKING ANTI-LOOSENING LOCKING DEVICE

(71) Applicant: GUANGZHOU BOSMA OPTOELECTRONIC TECHNOLOGY CO., LTD., Guangzhou (CN)

(72) Inventors: Aiquan Gao, Guangzhou (CN); Dexiang Zeng, Guangzhou (CN)

(21) Appl. No.: 15/972,248

(22) Filed: May 7, 2018

Related U.S. Application Data
(63) Continuation-in-part of application No. 14/913,381, filed on Feb. 22, 2016.

(30) Foreign Application Priority Data
Aug. 22, 2013 (CN) 201310371540.6

(51) Int. Cl. F41G 11/00; F16B 2/18; F16B 2/12

(52) U.S. Cl. CPC F41G 11/003; F16B 2/12; F16B 2/185

(57) ABSTRACT

The present invention discloses a fast-locking anti-loosening locking device, comprising a body, a pull rod threads, a cap nut, a pressing block and an eccentric handle, wherein the pull rod penetrates through the pressing block and the body; the pressing block is connected onto the pull rod in a sliding manner; the inner end of the pull rod is articulated with the inner end of the eccentric handle, and the outer end of the pull rod penetrates through the body to be in screw-thread fit with the cap nut; a mounting hole is formed in the eccentric handle, and is internally provided with a wrench and a spring. The fast-locking anti-loosening locking device has the advantage that even through in the case of firearm firing, the device can still maintain a locked state instead of loosening, thereby ensuring the reliability and practicality of the mechanism.

### CROSS REFERENCE TO RELATED APPLICATIONS

The present application is a Continuation-in-part Application of U.S. patent application No. Ser. 14/913,381 filed on Feb. 22, 2016, which is a U.S. National Stage Application of PCT application No. PCT/CN2014/084222 filed on Aug. 13, 2014, which in turn claims the benefits of Chinese Patent Application No. 201310371540.6 filed on Aug. 22, 2013. The contents of all of the above are hereby incorporated by reference.

### TECHNICAL FIELD

The present invention relates to a fast-locking anti-loosening locking device,

### BACKGROUND

When in use of firearms, the sighting scope bracket, butt or other accessories are usually locked on the guide rails of firearms by a locking device having an eccentric structure. However, in the existing practical applications, some firearm accessories cannot be locked by the locking device due to too small guide rails or too large guide rails. Meanwhile, the existing locking device is likely to loosen, and this may make the use of firearms inconvenient and even cause serious consequences.

### SUMMARY

An objective of the present invention is to provide a fast-locking anti-loosening locking device which can be adjusted to adapt to guide rails of different sizes and which has a function of anti-loosening, in order to overcome the deficiencies in the prior art.

To achieve the above objective, the present invention employs the following technical solution:

the fast-locking anti-loosening locking device comprising a body, a pull rod with threads, a cap nut, a pressing block and an eccentric handle, characterized in that the pressing block is arranged on one side of the body; the pull rod penetrates through the pressing block and the body; the pressing block is connected onto the pull rod in a sliding manner; the inner end of the putt rod is articulated with the inner end of the eccentric handle, and the outer end of the pull rod penetrates through the body to be in screw-thread fit with the cap nut; a mounting hole is formed in the eccentric handle, and is internally provided with a wrench and a spring; the middle part of the wrench is articulated onto the inner wall of the mounting hole; one end of the spring abuts against the bottom wall of the mounting hole, and the other end of the spring abuts against the inner end of the wrench; the spring is in a compressed state; a notch is formed in the inner end of the pull rod; the bottom wall of the notch is provided, with a protrusion extending outwards; and the outer end of the wrench penetrates through the mounting hole and can abut against the side face of the protrusion.

The operating principle is as follows: when the device is used, the guide rails are positioned between the pressing block and the body; the body is in threaded connection with the pull rod, and, can be positioned on the pull rod axially; according to the sizes of the guide rails, the pressing block slides to adjust the distance between the pressing block and the body to adapt to the guide rails of different sizes; when the eccentric handle is in an unlocked state, under the elastic force effect of the spring, the outer end of the wrench abuts against the bottom wall of the notch, the eccentric handle rotates, and simultaneously the wrench slides on the bottom wall of the notch; when the outer end of the wrench slides out from the bottom wall of the notch, the elastic force of the spring pushes the inner end of the wrench, the wrench swings, the outer end of the wrench swings downwards, and the outer end of the wrench abuts against the side face of the protrusion; right now, the eccentric handle is in a locked state and cannot rotate in an opposite direction; after the eccentric handle abuts against the pressing block by rotating the pull rod, the eccentric handle can play a tightening role in the pressing block, the pressing block is prevented from sliding to cause loosening; and even through in the case of firearm firing, the device can still maintain the locked state instead of loosening, thereby ensuring the reliability and practicality of the mechanism.

In the fast-locking anti-loosening locking device, the cap nut is clamped into a slot on the body by two opposite sides of a hexagon, and two lateral sides of the slot clamp the cap nut to prevent the cap nut from rotating to loosen after locking.

In the fast-locking anti-loosening locking device, the outer end of the wrench is provided with a square tongue, the cross sectional area of the tongue is smaller than that of the middle part of the wrench, and the tongue penetrates through the mounting hole and can abut against the side face of the protrusion.

In the fast-locking anti-loosening locking device, an avoiding groove capable of enabling the protrusion to pass through is formed in the inner end of the eccentric handle, a through hole communicating with the mounting hole is formed, in the side wall of the avoiding groove, and the tongue penetrates through the through hole.

In the fast-locking anti-loosening locking device, a pin is fixedly arranged inside the mounting hole, and the middle part of the wrench is connected onto the pin and can rotate around the pin.

In the fast-locking anti-loosening locking device, a spring seat is fixedly arranged on one end of the spring, and the spring seat abuts against the inner end of the wrench. In the embodiment, one end of the spring abuts against the inner end of the wrench by the spring seat, by setting the spring seat, the compression degree of the spring can be further increased, the elastic force of the spring for the handle is increased, and moreover, the spring seat can apply thrust for the wrench preferably.

In the fast-locking anti-loosening locking device, wheat the eccentric handle rotates to a position vertical to the pull rod, the tongue can abut against the protrusion under the effect of elastic force.

In the fast-locking anti-loosening locking device, after the wrench is pressed to the maximal degree, the tongue of the wrench is warped up to he separated from the protrusion.

In the fast-locking anti-loosening locking device, the locking force when the pressing block is locked by the eccentric handle is adjustable, the distance between the inner end of the pull rod and the body can be adjusted by rotating the pull rod, and the locking force between the pressing block and the body is changed by the change of the distance.

Compared with the prior art, the present invention has the following advantages:

the distance between the inner end of the pull rod and the body is adjusted by rotating the cap nut, and the locking force and distance between the pressing block and the body are changed by the change of the distance. Therefore, the fast-locking anti-loosening locking device of the present invention may be adjusted to adapt to guide rails of different sizes and lock the pressing block; since the cap nut is a regular hexagon and there is a slot matched with the regular hexagon on the body, by clamping the cap nut into the slot, the cap nut is prevented from loosening and the purpose of anti-loosening is achieved; even through in the case of firearm firing, the fast-locking anti-loosening locking device can still maintain a locked state instead of loosening, thereby ensuring the reliability and practicality of the mechanism.

### BRIEF DESCRIPTION OF THE DRAWINGS

FIG. 1 is an exploded view 1 of a locking device;

FIG. 2 is an exploded view 2 of the locking device;

FIG. 3 is a sectional view of an eccentric handle component;

FIG. 4 is a sectional view of the locking device in another direction;

FIG. 5 is a structure, diagram of the eccentric handle;

FIG. 6 is a schematic diagram of the locking device in a locked state.

In the figures, 1, pull rod; 1a, protrusion; 2, wrench; 3, countersunk head screw; 4, spring seat; 5, spring; 6, pin; 7, eccentric handle; 7a, mounting hole; 7b, avoiding groove; 7c, through hole; 8, pressing block; 9, body; 10, cap nut; 11, notch; and 12, tongue.

### DESCRIPTION OF THE EMBODIMENTS

The technical scheme of the present invention is further described with reference to the accompanying drawings by specific embodiments of the present invention, but the present invention is not restricted by the above-mentioned embodiments.

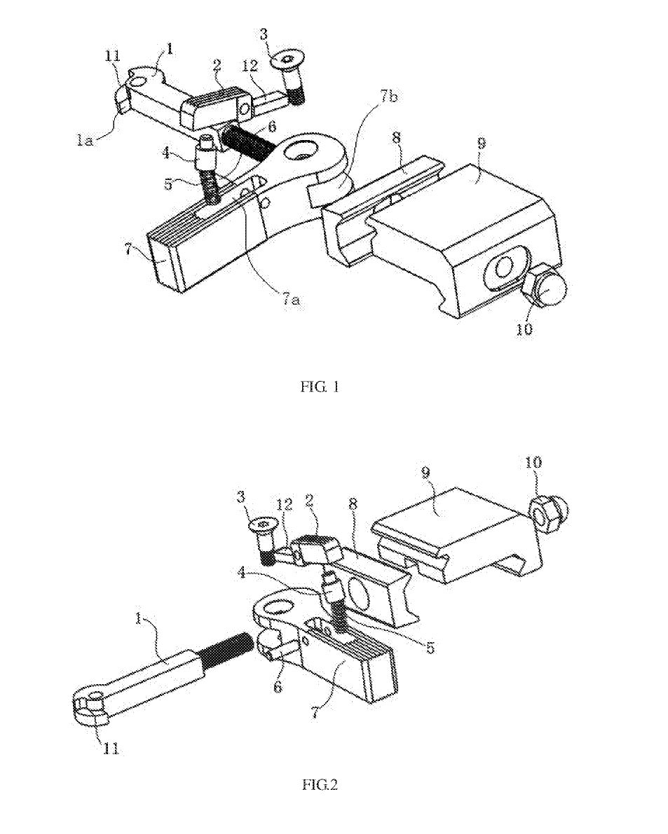

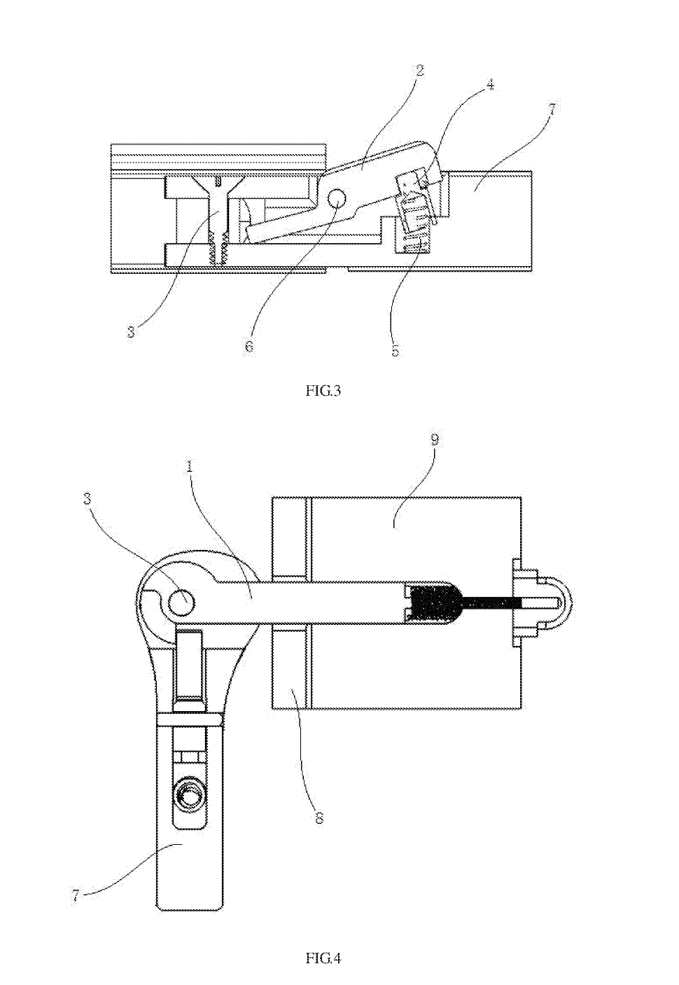

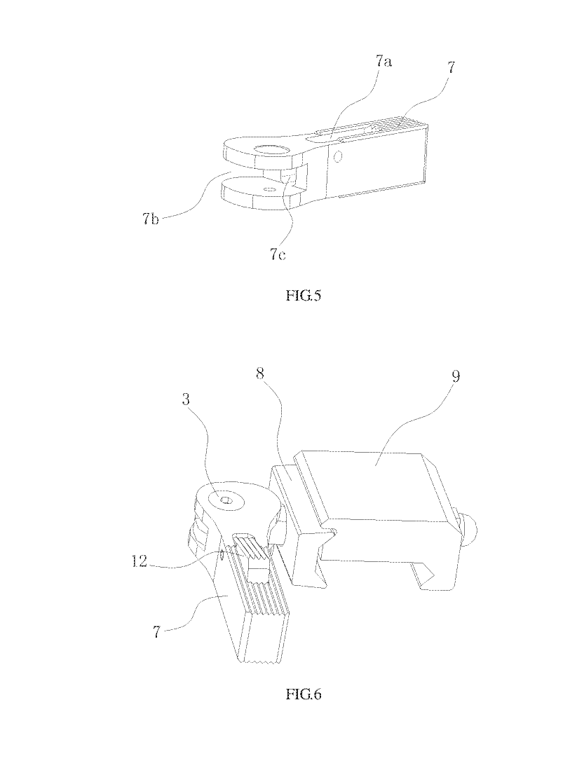

As shown in FIG. 1 to FIG. 6, the fast-locking anti-loosening locking device comprises a body 9, a pull rod 1 with threads, a cap nut 10, a pressing block 8 and an eccentric handle 7; the pressing block 8 is arranged on one side of the body 9; the pull rod 1 penetrates through the pressing block 8 and the body 9; the pressing block 8 is connected onto the pull rod 1 in a sliding manner; the inner end of the pull rod 1 is articulated with the inner end of the eccentric handle 7, and the outer end of the pull rod 1 penetrates through the body 9 to be in screw-thread fit with the cap nut 10; a mounting hole 7a is formed in the eccentric handle 7, and is internally provided with a wrench 2 and a spring 5; the middle part of the wrench 2 is articulated onto the inner wall of the mounting hole 7a; one end of the spring 5 abuts against the bottom wall of the mounting hole 7a, and the other end of the spring 5 abuts against the inner end of the wrench 2; the spring 5 is in a compressed state; a notch 11 is formed in the inner end of the pull rod 1; the bottom wall of the notch 11 is provided with a protrusion 1a extending outwards; and the outer end of the wrench 2 penetrates through the mounting hole 7a and can abut against the side face of the protrusion 1a.

As an embodiment, a pin 6 is fixedly arranged inside the mounting hole 7a, and the middle part of the wrench 2 is connected onto the pin 6 and can rotate around the pin 6.

The pressing block 8 is arranged on one side of the body 9 and is matched with the body 9 for being clamped and fixed on the guide rails; the pull rod 1 penetrates through the pressing block 8 and the body 9 respectively; one end of the pull rod 1 is articulated with the eccentric handle 7 by a countersunk head screw 3, and the other end of the pull rod penetrates through the body 9 to be in screw-thread fit with the cap nut 10; the distance between the pressing block 8 and the body is adjusted by rotating the pull rod 1 to adapt to guide rails of different sizes; and simultaneously, the locking force of the eccentric handle 7 for the pressing block 8 also can be adjusted,

As shown in FIG. 1 in the embodiment, the outer end of the wrench 2 is provided with a square tongue 12, the cross sectional area of the tongue 12 is smaller than that of the middle part of the wrench 2, and the tongue 12 penetrates through the mounting hole 7a and can abut against the side face of the protrusion 1a.

As shown in FIG. 5, in the embodiment, an avoiding groove 7b capable of enabling the protrusion 1a to pass through is formed in the inner end of the eccentric handle 7, a through hole 7c communicating with the mounting hole 7a is formed in the side wall of the avoiding groove 7a, and the tongue 12 penetrates through the through hole 7c.

As another embodiment, when the eccentric handle 7 rotates to a position vertical to the pull rod 1, the pressing block can be blocked, and the tongue 12 of the wrench 2 can abut against the protrusion 1a under the effect of elastic force, so that the eccentric handle 7 is prevented from rotating. After the wrench 2 is pressed to the maximal degree, the tongue 12 of the wrench 2 can be separated from the notch 11 of the pull rod 1, right now, the eccentric handle 7 can rotate outwards, and the pressing block 8 and the body 9 are loosened, so that the operation is extremely simple and convenient, and the device is reliable and durable. The wrench 2 and the tongue 12 are of an integral structure, the structure is simple and reliable, and the device is easy to assemble.

As shown in FIG. 1, in the embodiment, a spring seat 4 is fixedly arranged on one end of the spring 5, and the spring seat 4 abuts against the inner end of the wrench 2. In the embodiment, one end of the spring 5 abuts against the inner end of the wrench 2 by the spring seat 4, by setting the spring seat 4, the compression degree of the spring 5 can be further increased, the elastic force of the spring 5 for the handle is increased, and moreover, the spring seat 4 can apply thrust for the wrench 2 preferably. The spring 5 is pressed into the mounting hole 7a of the eccentric handle 7 by the spring seat 4. The head of the spring seat 4 is mounted inside a groove of the wrench 2.

Optionally, when the pressing block 8 begins to be locked with the body 9, the cap nut 10 is clamped, into a slot on the side face of the body 9 by two opposite sides of a hexagon, and two lateral sides of the slot clamp the cap nut 10 to prevent the cap nut 10 from rotating to loosen after locking. The two opposite sides of the cap nut 10 can be clamped by the slot on the side face of the body 9, so that the cap nut 10 is prevented from rotating to loosen.

The embodiments described in the present invention are provided for the sprit of the present invention by way of illustration only. Those skilled in the art can perform various modifications or supplementations for the described embodiments or adopt similar manners to replace, but without departing from the spirit and scope of the disclosure.

What is claimed is:

1. A fast-locking anti-loosening locking device, comprising a body (9), a pull rod (1) with threads, a cap nut (10), a pressing block (8) and an eccentric handle (7), characterized in that the pressing block (8) is arranged on one side of the body (9); the pull rod (1) penetrates through the pressing block (8) and the body (9); the pressing block (8) is connected onto the pull rod (1) in a sliding manner; the inner end of the pull rod (1) is articulated with the inner end of the eccentric handle (7), and the outer end of the pull rod (1) penetrates through the body (9) to be in screw-thread fit with the cap nut (10); a mounting hole (7a) is formed in the eccentric handle (7), and is internally provided with a wrench (2) and a spring the middle part of the wrench (2) is articulated onto the inner wall of the mounting hole (7a); one end of the spring (5) abuts against the bottom wall of the mounting hole (7a), and the other end of the spring (5) abuts against the inner end of the wrench (2); the spring (5) is in a compressed state; a notch (11) is formed in the inner end of the putt rod (1); the bottom wall of the notch (11) is provided with a protrusion (1a) extending outwards; and the outer end of the wrench (2) penetrates through the mounting hole (7a) and can abut against the side face of the protrusion (1a).

2. The fast-locking anti-loosening locking device according to claim 1, characterized in that the cap nut (10) is clamped into a slot on the body (9) by two opposite sides of a hexagon, and the cap nut (10) is clamped by two lateral sides of the slot.

3. The fast-locking anti-loosening locking device according to claim 1, characterized in that the outer end of the wrench (2) is provided with a square tongue (12), the cross sectional area of the tongue (12) is smaller than that of the middle part of the wrench (2), and the tongue (12) penetrates through the mounting hole (7a) and can abut against the side face of the protrusion (1a).

4. The fast-locking anti-loosening locking device according to claim 3, characterized in that an avoiding groove (7b) capable of enabling the protrusion (1a) to pass through is formed in the inner end of the eccentric handle (7), a through hole (7c) communicating with the mounting hole (7a) is formed in the side wall of the avoiding groove (7b), and the tongue (12) penetrates through the through hole (7c).

5. The fast-locking anti-loosening locking device according to claim 1, characterized in that a pin (6) is fixedly arranged inside the mounting hole (7a), and the middle part of the wrench is connected onto the pin (6) and can rotate around the pin (6).

6. The fast-locking anti-loosening locking device according to claim 1, characterized in that a spring seat (4) is fixedly arranged on me end of the spring (5), and the spring seat (4) abuts against the inner end of the wrench (2).

7. The fast-locking anti-loosening locking device according to claim 3, characterized in that, when the eccentric handle (7) rotates to a position vertical to the putt rod (1), the tongue (12) can abut against the protrusion (1a) under the effect of elastic force.

8. The fast-locking anti-loosening locking device according to claim 3, characterized in that, after the wrench (2) is pressed to the maximal degree, the tongue (12) of the wrench (2) is warped up to be separated from the protrusion (1a).
